(19) United States
(12) Patent Application Publication
(10) Pub. No.: US 2015/0146694 A1
(43) Pub. Date: May 28, 2015

(54) PRUNING A CANDIDATE CELL LIST FOR AN IDLE MODE UE AND A CONNECTED MODE UE

(71) Applicant: QUALCOMM Incorporated, San Diego, CA (US)

(72) Inventors: Thawatt GOPAL, San Diego, CA (US); Scott Allan HOOVER, Del Mar, CA (US); Tian MAI, San Diego, CA (US); Nitin PANT, San Diego, CA (US); Krishna Rao MANDADAPU, San Diego, CA (US); Daniel AMERGA, San Diego, CA (US); Muthukumaran DHANAPAL, San Diego, CA (US); Muralidharan MURUGAN, San Diego, CA (US); Tom CHIN, San Diego, CA (US)

(21) Appl. No.: 14/552,430

(22) Filed: Nov. 24, 2014

Related U.S. Application Data
(63) Continuation-in-part of application No. 14/323,656, filed on Jul. 3, 2014.
(60) Provisional application No. 61/908,633, filed on Nov. 25, 2013.
(60) Provisional application No. 61/955,617, filed on Mar. 19, 2014.

(51) Int. Cl. H04W 36/00

(52) U.S. Cl. CPC H04W 36/0083
USPC 370/332

(57) ABSTRACT

A method for determining candidate radio access technology (RAT) layers includes selecting one or more initial candidate RAT layer, for each configured RAT type of a UE, for a target RAT candidate list. The target can be for redirection or handover, for example. Each initial candidate RAT layer is selected regardless of network indicated RAT priorities and measurement object IDs. The method also includes selecting additional candidate RAT layers, for the list, based on the network indicated RAT priorities or the measurement object IDs. The method may be specified for when a UE is in a connected mode or an idle mode.

### CROSS-REFERENCE TO RELATED APPLICATIONS

This application claims the benefit under 35 U.S.C. §119(e) to U.S. Provisional Patent Application No. 61/908,633 entitled “SELECTION FOR TARGET INTRA-RAT AND INTER-RAT RESELECTION CANDIDATES,” filed on Nov. 25, 2013, and is a continuation-in-part of U.S. patent application Ser. No. 14/323,656 entitled “APPARATUS AND METHOD FOR PERFORMING INTER-RADIO ACCESS TECHNOLOGY CELL MEASUREMENT,” filed on Jul. 3, 2014, which claims the benefit of U.S. Provisional Patent Application No. 61/955,617 entitled “APPARATUS AND METHOD FOR PERFORMING INTER-RADIO ACCESS TECHNOLOGY CELL MEASUREMENT,” filed on Mar. 19, 2014, the disclosures of which are expressly incorporated by reference herein in their entireties.

### BACKGROUND

1. Field

Aspects of the present disclosure relate generally to wireless communication systems, and more particularly, to improving cell reselections, redirections, and/or handovers using a target candidate list when a network broadcasts or unicasts an increased number of target inter-RAT (IRAT) and/or inter-frequency reselection, redirection, and/or handover candidates.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the Universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA), which extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the present disclosure, a method for determining candidate RAT layers is disclosed. The method includes selecting one or more initial candidate RAT layers, for each configured RAT type of a UE, for a target RAT candidate list. The target can be for redirection or handover, for example. In one configuration, each initial candidate RAT layer is selected regardless of network indicated RAT priorities and measurement object ID. The method also includes selecting additional candidate RAT layers, for the list, based on the network indicated RAT priorities or measurement object IDs. In one configuration the method is specified for when a UE is in a connected mode or an idle mode.

Another aspect of the present disclosure is directed to an apparatus including means for selecting one or more initial candidate RAT layers, for each configured RAT type of a UE, for a target RAT candidate list. The target can be for redirection or handover, for example. In one configuration, each initial candidate RAT layer is selected regardless of network indicated RAT priorities and measurement object ID. The apparatus also includes means for selecting additional candidate RAT layers, for the list, based on the network indicated RAT priorities or measurement object IDs. In one configuration the apparatus is specified for when a UE is in a connected mode or an idle mode.

In another aspect of the present disclosure, a computer program product for determining candidate RAT layers is disclosed. The computer program product has a non-transitory computer-readable medium with non-transitory program code recorded thereon. The program code includes program code to select one or more initial candidate RAT layers, for each configured RAT type of a UE, for a target RAT candidate list. The target can be for redirection or handover, for example. In one configuration, each initial candidate RAT layer is selected regardless of network indicated RAT priorities and measurement object ID. The program code also includes program code to select additional candidate RAT layers, for the list, based on the network indicated RAT priorities or measurement object IDs. In one configuration the computer program product is specified for when a UE is in a connected mode or an idle mode.

Another aspect of the present disclosure is directed to an apparatus having a memory and one or more processors coupled to the memory. The processor(s) is configured to select one or more initial candidate RAT layers, for each configured RAT type of a UE, for a target RAT candidate list. The target can be for redirection or handover, for example. In one configuration, each initial candidate RAT layer is selected regardless of network indicated RAT priorities and measurement object ID. The processor(s) is also configured to select additional candidate RAT layers, for the list, based on the network indicated RAT priorities or measurement object ID. In one configuration the apparatus is specified for when a UE is in a connected mode or an idle mode.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a flow diagram illustrating a method for improved cell reselection according to one aspect of the present disclosure.

FIG. 6 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

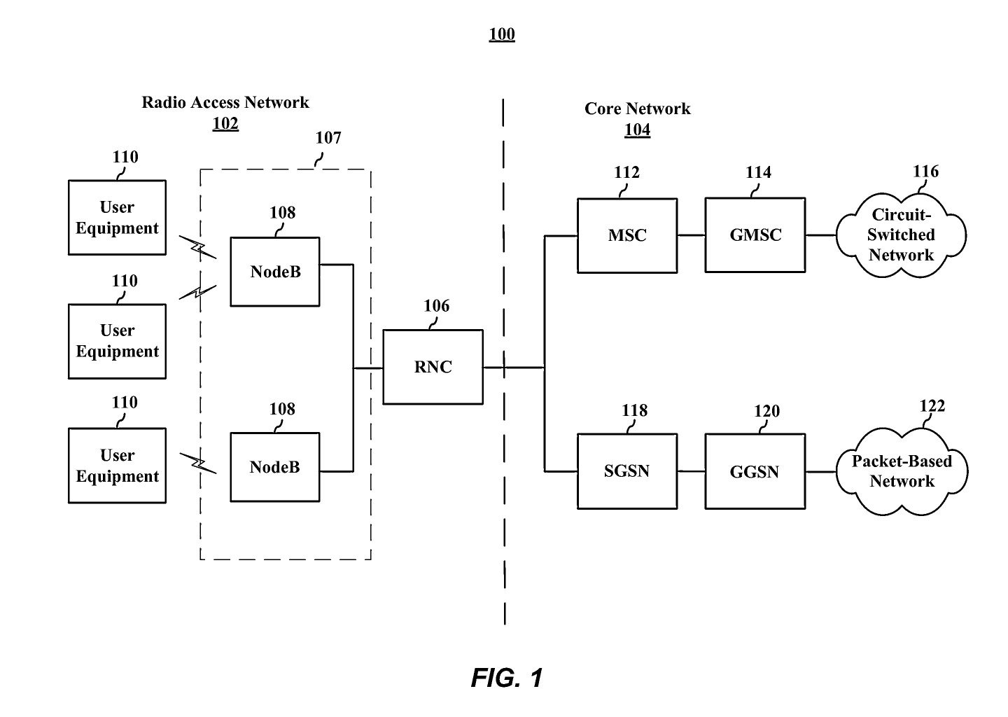

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a radio access network (RAN) 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

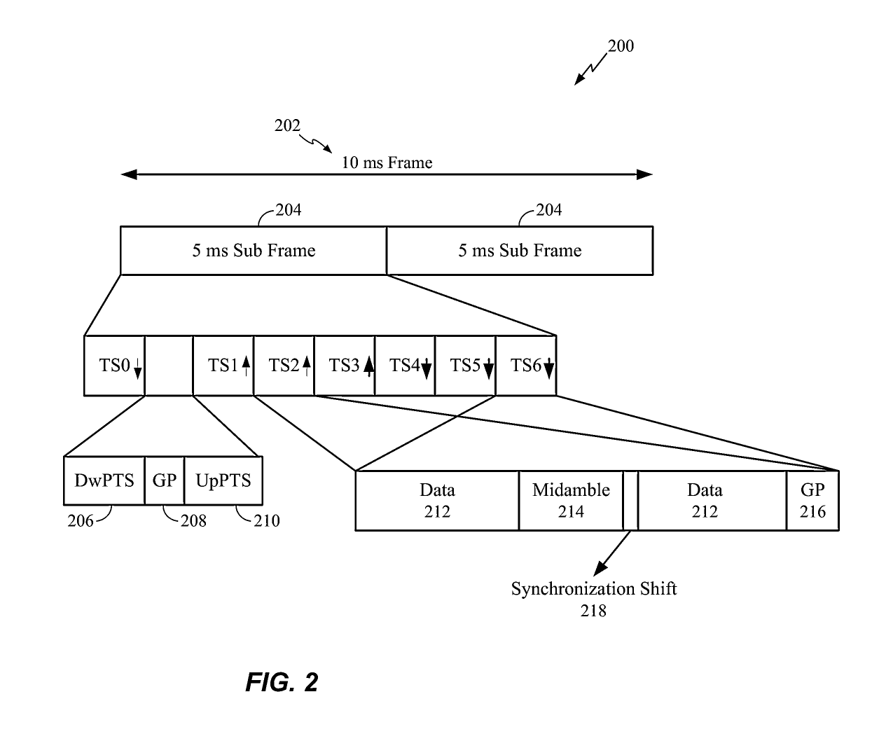

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

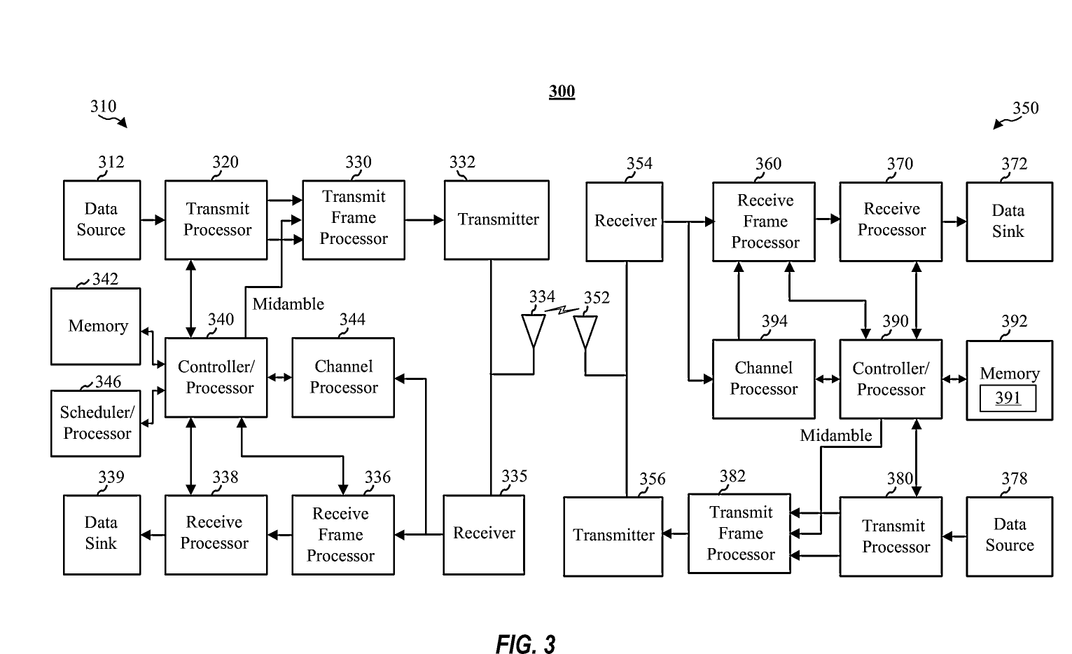

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a selecting module 391 which, when executed by the controller/processor 390, configures the UE 350 to selecting one candidate RAT layer for each configured RAT of a UE, for a target reselection candidate list. The candidate RAT layers are selected regardless of network indicated RAT priorities. A scheduler/processor 346 at the node B 310 may allocate resources to the UEs and schedule downlink and/or uplink transmissions for the UEs.

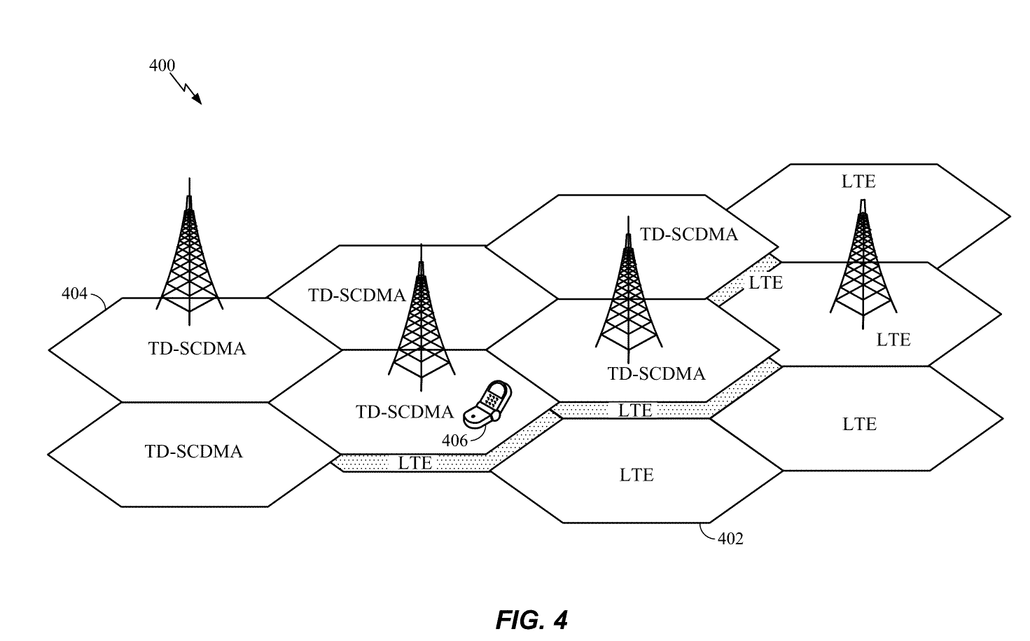

FIG. 4 illustrates coverage of a newly deployed network, such as an LTE network and also coverage of a more established network, such as a TD-SCDMA network. A geographical area 400 may include LTE cells 402 and TD-SCDMA cells 404. A user equipment (UE) 406 may move from one cell, such as a TD-SCDMA cell 404, to another cell, such as an LTE cell 402. The movement of the UE 406 may specify a handover or a cell reselection.

The handover or cell reselection may be performed when the UE moves from a coverage area of a TD-SCDMA cell to the coverage area of an LTE cell, or vice versa. A handover or cell reselection may also be performed when there is a coverage hole or lack of coverage in the TD-SCDMA network or when there is traffic balancing between the TD-SCDMA and LTE networks. As part of that handover or cell reselection process, while in a connected mode with a first system (e.g., TD-SCDMA) a UE may be specified to perform a measurement of a neighboring cell (such as LTE cell). For example, the UE may measure the neighbor cells of a second network for signal strength, frequency channel, and base station ID. The UE may then connect to the strongest cell of the second network. Such measurement may be referred to as inter-radio access technology (IRAT) measurement.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. The measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold.

### Idle Mode Cell Reselection Via an Improved Cell Reselection List

Inter-radio access technology (IRAT) reselection from a first network, such as an LTE network, to a second network, such as a TD-SCDMA network, may be specified when a UE is operating in an idle mode or a discontinuous reception (DRX) mode. In some cases, a multi-frequency network, such as a TD-SCDMA network, may be one of the networks specified for the IRAT reselection. Although the present application is described with respect to TD-SCDMA, GSM and LTE, the present application is not limited to TD-SCDMA, GSM and LTE networks as other networks are also contemplated.

In a conventional network, based on the current standards implementation, such as 3GPP TS 36.133, UEs are specified to support a minimum of layers, such as frequency layers, for RAT reselection. In one configuration, the minimum number of layers is eight. The layers may include a serving RAT layer, serving RAT inter-frequency layers, and/or target RAT layers. For some networks, such as LTE, each layer refers to one frequency. For other networks, such as GSM, each layer refers to a group of frequencies. Specifically, a GSM RAT may include up to sixteen frequency groups. More specifically, the GSM RAT may include thirty two absolute radio frequency channel numbers (ARFCNs). Additionally, for a conventional TD-SCDMA network, each layer refers to one frequency. Still, in one configuration, based on improved memory use, for a TD-SCDMA network, one layer three (L3) TD-SCDMA layer refers to three layer one (L1) frequencies. In the present disclosure, the layers refer to level three layers and the frequencies refer to layer one layers.

In a conventional network, a list of layers for cell reselection is broadcast from a source RAT. In one example, for an LTE to TD-SCDMA cell reselection, the target RAT layers are broadcast from the source LTE cell and a list of TD-SCDMA layers are also broadcast from the source LTE cell.

In the present application, layers may be referred to as frequency layers. Moreover, the terms layers and frequencies are used interchangeably with respect to the LTE example discussed below because each LTE layer corresponds to a single frequency. It is to be understood, for the present application, the term frequency may be intended to describe a layer, and vice versa, when other RATs, such as GSM or TD-SCDMA, that include multiple frequencies in a single layer are considered. Moreover, for RATs that include multiple frequencies in a single layer, the term frequency may refer to a frequency group.

In a deployment that supports more than one network, such as an LTE network and TD-SCDMA network, it is likely that the first network, such as an LTE network, broadcasts more than eight layers as a possible set of reselection targets. Still, in some cases, due to memory constraints of the UE, the UE may prune layers from the list of target layers transmitted by the first network. Additionally, or alternatively, the UE may prune layers to limit an amount time for searching for a RAT during a reselection process.

That is, the UE may truncate the layers when the network broadcasts a list of layers including target reselection frequencies, such as the source RAT inter-frequencies and/or target RAT frequencies. Specifically, the UE may truncate layers when the list of transmitted layers is greater than the minimum standard specifications and greater than the UE's memory capacity. For example, if the minimum standard specification is eight layers, the UE may truncate the layers to eight layers or a number N that is greater than eight and less than or equal to the UE memory capacity.

In some cases, a RAT may broadcast on a frequency that has been pruned from the list. Still, the UE may only perform the reselection to the frequencies that remain on the truncated list. Thus, the UE may be unaware of the broadcasted frequency as a result of the pruned layer and the UE may not perform the reselection to the frequency that has been pruned from the list. Therefore, because the UE is limited to performing the reselection to the layers that remain on the truncated list, it is desirable to improve the process of truncating layers from a list of target reselection candidates.

According to an aspect of the present disclosure, a UE maintains one layer for each RAT type configured for the UE as a candidate for reselection in a candidate reselection list. In one configuration, the layer for each RAT type is selected regardless of a priority of the layer. Furthermore, in the present configuration, the remaining available layers in the candidate reselection list may be populated based on a priority of each layer. The selection of the layers for the IRAT reselection list may be customized based on the serving network operator's preference. That is, a specific policy may be specified for each public land mobile network (PLMN) ID associated with a network operator.

The candidate reselection list may be referred to as the target reselection candidate list or the IRAT candidate reselection list. Moreover, the candidate reselection list includes inter-RAT candidates, intra-RAT candidates, inter-frequency candidates, and intra-frequency candidates for both cell reselection. Furthermore, the number of layers specified for the target reselection candidate list may be based on a size of UE memory and/or an estimated time for searching the layers. That is, the number of layers may be set to reduce power consumption by the UE.

In one configuration, the candidate reselection list is specified to include layers that will be used by the UE to perform an active search. The search periodicity may be based on a total number of active layers in the measurement list and the active search list. Additionally, or alternatively, the search periodicity may be pre-determined and/or user defined.

As discussed above, in one configuration, a UE selects one layer of each configured RAT type in a candidate reselection list regardless of a priority of the layer configured by the network. For example, if a UE is configured for an LTE network, a GSM network, and a TD-SCDMA network, the UE may select one layer for the LTE network, one layer for the GSM network, and one layer for the TD-SCDMA network for the candidate reselection list. The selected layers are in addition to the layer of the serving network. Furthermore, the UE may fill the remaining available layers in the candidate reselection list based on a priority setting for each layer. The priority setting may be received from broadcast channel overhead messages, such as SIB-5, SIB-6, and/or SIB-7 messages. In one configuration, as previously discussed, the maximum number of layers in the candidate reselection list is eight. It should be noted that in one aspect of the present disclosure, the number of supported frequencies does not include the frequency of the serving layer.

Furthermore, as previously discussed, the selection of the layers for the IRAT reselection list may be customized based on a preference of the serving network operator. That is, the UE may determine the PLMN ID of the serving cell and compare the PLMN ID to a list of known PLMN IDs to determine the network operator's preference for the candidate reselection list. In one example, a network operator, such as an LTE network operator, may specify that the UE selects one LTE layer, one GSM layer, and one TD-SCDMA layer in the candidate reselection list based on network configured priority settings associated with each candidate frequency. It should be noted that network configured priority settings are applicable to specific types of networks, such as LTE networks. Additionally, for other networks, such as non-LTE networks, the network operator may use priority based settings or non-priority based settings. Thus, in this example, when a network operator does not provide priority settings for a specific RAT, the UE may assume a configurable default priority setting for a particular candidate RAT. The default priority setting may be used to associate a candidate frequency for a particular RAT.

In one example, while a UE is currently served by an LTE cell, the UE determines the PLMN ID of the network operator to determine the layers for the RAT types specified for the candidate reselection list. In the present example, the network operator may specify that the UE selects one LTE layer, one GSM layer, and one TD-SCDMA layer in the candidate reselection list. Therefore, the UE may maintain a maximum of eight layers that include the serving layer, such as LTE, another LTE layer, one GSM layer, and one TD-SCDMA layer. The remaining four layers are then selected based on an assigned layer priority.

In one configuration, when more than twelve TD-SCDMA frequencies, such as L3 layers, are specified, the UE may select twelve or fewer TD-SCDMA frequencies and prune the remaining frequencies. Furthermore, a total of frequencies may be based on a specific setting, such as a setting set by the standards or a setting indicated by the network. Thus, in one configuration, the UE selects three TD-SCDMA frequencies, such as one TD-SCDMA layer, with the highest priority and selects the remaining nineteen frequencies based on a priority specified by the network.

TABLE 1 illustrates an example for selecting layers for a candidate reselection list according to an aspect of the present disclosure. It should be noted that in the examples shown in TABLES 1-4, the layer for the serving RAT is also included in the candidate reselection list and is not shown as being included in the pruned lists. Furthermore, in the examples shown in TABLES 1-4, the network operator specifies that the UE selects one LTE layer, one GSM layer, and one TD-SCDMA layer in the candidate reselection list. Finally, in the examples shown in TABLES 1-4, the candidate reselection list is referred to as the pruned list.

TABLE 1
16 TD-SCDMA layers - priority 5
1 GSM layer (16 Frequency groups)- priority 6
6 LTE layers - priority 7
Pruned List (Conventional network): 6 LTE + 1 GSM (16 Frequency
groups)
Pruned List (Present example): 1 GSM (14 Frequency groups) + 5 LTE +
1 TD-SCDMA (3 Frequencies)

As shown in example of TABLE 1, in a conventional network, the UE selects all six identified LTE layers because LTE has the highest priority. Additionally, in the conventional network, the UE selects the GSM layer which has the next highest priority after LTE. TD-SCDMA is not selected.

Alternatively, in the example of TABLE 1, based on aspects of the present disclosure, the UE selects one LTE layer, one GSM layer, and one TD-SCDMA layer based on the configuration specified by the network operator. Furthermore, the remaining LTE layers are selected for the four available layers remaining in the candidate reselection list. Furthermore, in the present example, sixteen frequencies are specified for the GSM layer. Still, because the TD-SCDMA layer is associated with three frequencies, the number of frequencies is reduced to fourteen to accommodate the twenty-two frequency limitation. That is, the twenty-two frequencies are derived from the five frequencies specified from the five LTE layers, the fourteen frequencies specified for the one GSM layer, and three frequencies specified for the one TD-SCDMA layer.

As shown in TABLE 1, for the conventional network, the TD-SCDMA layer was pruned from the candidate reselection list. Still, based on an aspect of the present disclosure, one TD-SCDMA layer is added to the candidate reselection list.

TABLE 2 illustrates another example for selecting layers for a candidate reselection list according to an aspect of the present disclosure.

TABLE 2
1 GSM layer (16 Frequencies) - priority 5
16 TD-SCDMA layers - priority 6
6 LTE layers - priority 7
Pruned List (Conventional network): 6 LTE + 1 TDS (1 Frequency)
Pruned List (Present example): 1 GSM (14 Frequencies) + 5 LTE +
1 TD-SCDMA (3 Frequencies)

As shown in example of TABLE 2, in a conventional network, the UE selects all six identified LTE layers because LTE has the highest priority. Additionally, in the conventional network, the UE selects one TD-SCDMA layer which has the next highest priority after LTE. No GSM layer is selected.

Alternatively, in the example of TABLE 2, based on aspects of the present disclosure, the UE selects one LTE layer, one GSM layer, and one TD-SCDMA layer based on the configuration specified by the network operator. Furthermore, the remaining LTE layers are selected for the four available layers remaining in the candidate reselection list. Additionally, in the present example, sixteen frequencies are specified for the GSM layer. Still, because the TD-SCDMA layer is associated with three frequencies, the number of frequencies is reduced to fourteen to accommodate the twenty-two frequency limitation. That is, the twenty-two frequencies are derived from the five frequencies specified from the five LTE layers, the fourteen frequencies specified for the one GSM layer, and three frequencies specified for the one TD-SCDMA layer.

As shown in TABLE 2, in the conventional network, the GSM layer is pruned from the candidate reselection list. Still, based on an aspect of the present disclosure, the GSM layer is added to the candidate reselection list. Furthermore, the number of TD-SCDMA frequencies is increased from one to three. The number of frequencies may be increased by mapping one layer, such as a TD-SCDMA layer, to three frequencies, such as three TD-SCDMA frequencies.

TABLE 3 illustrates yet another example for selecting layers for a candidate reselection list according to an aspect of the present disclosure.

TABLE 3
16 TD-SCDMA layers - priority 4
1 GSM layer (2 Frequencies) - priority 5
2 LTE layers - priority 6
Pruned List (Conventional network): 2 LTE + 1 GSM (2 Frequencies) +
4 TD-SCDMA (4 Frequencies)
Pruned List (Present example): 2 LTE + 1 GSM (2 Frequencies) +
4 TDS (12 Frequencies)

As shown in example of TABLE 3, in a conventional network, the UE selects the two identified LTE layers because LTE has the highest priority. Additionally, the UE selects one GSM layer which has the next highest priority after LTE. Moreover, the UE selects the remaining four TD-SCDMA layers. As previously discussed, in a conventional network, one TD-SCDMA layer is associated with one frequency. Still, according to an aspect of the present disclosure, one TD-SCDMA layer is associated with three frequencies. It should be noted that the conventional list reduces the number of frequencies when one layer is mapped to one frequency.

Alternatively, in the example of TABLE 3, based on aspects of the present disclosure, the UE selects one LTE layer, one GSM layer, and one TD-SCDMA layer based on the configuration specified by the network operator. Furthermore, the one remaining LTE layer is selected for one of the four available layers remaining in the candidate reselection list. Furthermore, in the present example, the GSM layer is selected because the GSM layer has the next highest priority after the LTE layer. Still, because only one GSM layer is specified, the remaining three available layers in the candidate reselection list are allocated to the specified TD-SCDMA layers. In the present example, the total number of frequencies for the layers selected for the list is less than twenty-two. Therefore, the UE does not prune frequencies from the selected layers.

As shown in TABLE 3, for the conventional network, the number of TD-SCDMA frequencies is three. Still, based on an aspect of the present disclosure, the number of TD-SCDMA frequencies has increased from four to twelve.

TABLE 4 illustrates still yet another example for selecting layers for a candidate reselection list according to an aspect of the present disclosure.

TABLE 4
16 TD-SCDMA layers - priority 4
1 GSM layer (2 Frequencies) - priority 5
1 LTE layer - priority 6
Pruned List (Conventional network): 1 LTE + 1 GSM (2 Frequencies) +
5 TD-SCDMA (5 Frequencies)
Pruned List (Present example): 1 GSM (2 Frequencies) + 1 LTE +
4 TD-SCDMA (12 Frequencies)

As shown in example of TABLE 4, in a conventional network, the UE selects the one identified LTE layer because LTE has the highest priority. Furthermore, the UE selects one GSM layer which has the next highest priority after LTE. Moreover, the UE selects the remaining five TD-SCDMA layers for the candidate reselection list.

Alternatively, in the example of TABLE 4, based on an aspect of the present disclosure, the UE selects one LTE layer, one GSM layer, and one TD-SCDMA layer based on the configuration specified by the network operator. Furthermore, because there are no remaining LTE layers for the four available layers remaining in the candidate reselection list, the UE selects the layer with the next highest priority. In the present example, the GSM layer has the next highest priority after the LTE layer. Still, because only one GSM layer is specified and the GSM layer is already in the list, the remaining four available layers in the list are allocated to the remaining TD-SCDMA layers.

In the present example, the total number of frequencies for the layers selected for the list is less than twenty-two. Therefore, the UE does not prune frequencies from the selected layers. Moreover, in the present example, the candidate reselection list has one additional space available, however, the number of L1 TD-SCDMA frequencies is capped at twelve. Therefore, only four L3 TD-SCDMA layers are selected.

As shown in TABLE 4, in the conventional network, the number of TD-SCDMA frequencies is five. Still, based on an aspect of the present disclosure, the number of TD-SCDMA frequencies has increased from five to twelve.

Connected Mode Cell Redirection or Handover Via an Improved Connected Mode Measurement Candidate List

In a conventional network, when a UE is in a connected mode, the network may configure multiple IRAT frequencies to be measured. For example, a UE may be in a connected mode in an LTE network and the network may configure multiple TD-SCDMA frequencies and/or GSM frequencies for an IRAT measurement. Moreover, in the conventional network, the UE truncates excess frequencies from the IRAT measurement list based on pruning criteria. It should be noted that in the present disclosure IRAT refers to both inter-RAT and intra-RAT.

Specifically, in the conventional network, a maximum of number of supported measurement layers is based on a layer threshold, such as, for example, eight layers including the serving layer. A radio resource controller may truncate measurement layers if the number of configured layers is greater than the layer threshold.

When a UE is in a connected mode, the network does not configure a priority for layers on an IRAT measurement list. Therefore, the network may prune layers without using the network configured priorities. For example, the network may prune the layers based on the measurement object IDs. Of course, the network is not limited to pruning the layers based on the measurement object IDs and may prune the layers based on other criteria. That is, the UE prunes the layers having the highest measurement object ID (i.e., the measurement object ID having an ID number that is greater than the other ID numbers). Thus, in some cases, a GSM measurement object may get pruned from the IRAT measurement list if the GSM measurement object was the last measurement object configured by the network such that the GSM measurement object has the highest measurement object ID. Still, in this example, the GSM candidate frequencies may be valid frequencies and the UE may have pruned a valid GSM candidate frequency. Moreover, the list may include a large number of other RATs without including any GSM candidate frequencies. Therefore, it is desirable to improve the pruning of candidate frequencies/layers from an IRAT measurement list when a UE is in a connected mode. In the present application, each measurement object may correspond to a specific frequency or group of frequencies.

Aspects of the present disclosure are directed to mitigating the pruning of valid candidate frequencies from a IRAT measurement list. In one configuration, the pruning is specified when the number of candidate frequencies for measurement, reported by the network, is greater than a threshold while a UE is in a connected mode.

As previously discussed, in the conventional network, the UE adds layers to the IRAT measurement list based on the measurement object ID. Furthermore, in the conventional network, the network will first configure the serving RAT and then configure the IRAT measurements so that serving RAT inter-frequency measurements will be prioritized before the intra-RAT measurements. Thus, the conventional network prioritizes the serving RAT measurements

In the present configuration, the IRAT measurement list is initially populated with a pre-determined number of layers. In one configuration, the pre-determined number of initial layers includes one serving LTE layer, one LTE inter-frequency layer, one GSM layer, and two TD-SCDMA layers. Furthermore, in this configuration, each LTE layer corresponds to one LTE frequency. Additionally, the GSM layer corresponds to a group of GSM layers, up to a maximum GSM frequency threshold, such as, for example, thirty-two absolute radio-frequency channel numbers. Finally, each TD-SCDMA layer corresponds to a maximum of three TD-SCDMA frequencies or UTRA-TDD absolute radio frequency channel numbers UARFCN.

After the initial layer population of the IRAT measurement list for the aforementioned pre-determined number of layers, the radio resource controller adds layers to the IRAT measurement list based on measurement object IDs. That is, the radio resource controller adds layers based on the lowest measurement object ID until the layer threshold is satisfied.

According to an aspect of the present disclosure, after the IRAT measurement list has been populated with layers up to the layer threshold, the UE may further prune the IRAT measurement list so that a total number of frequencies is less than or equal to a frequency threshold, such as twenty-two frequencies. In this configuration, one LTE layer corresponds to one LTE frequency, one TD-SCDMA layer corresponds to one TD-SCDMA frequency, and one GSM layer corresponds to all configured GSM measurement objects up to a GSM frequency threshold, such as thirty-two GSM absolute radio-frequency channel numbers (ARFCNs).

As previously discussed, the radio resource controller may prune out frequencies when the number of frequencies is greater than the frequency threshold. Still, the radio resource controller will keep at least one LTE serving layer, one LTE inter-frequency layer, one GSM layer, and two TD-SCDMA layers.

According to aspects of the present disclosure, the radio resource controller may use an active list and a dormant list. The active list refers to the layers that are actively searched for valid cells. The dormant list may include candidate layers/frequencies that are not actively searched. In one configuration, the radio resource controller cycles through candidate layers/frequencies using the active and dormant search list. Specifically, in this configuration, the active search list will be actively searched and one or more layers may be swapped out with a layer from the dormant list if a search does not yield a valid cell after a period of time. In one configuration, the dormant list includes TD-SCDMA layers. TD-SCDMA may be selected as a candidate for a dormant list because of the large number of frequencies that are configured. Of course, aspects of the present disclosure are not limited to the dormant list being only for TD-SCDMA layers and other RAT layers are also contemplated for the dormant list. For example, a dormant list and an active list may also be specified for LTE layers.

Furthermore, the active measurement list may include LTE measurement objects that are not pruned, TD-SCDMA measurement objects that are not in the dormant list, and all configured GSM measurement objects subject to a predefined maximum threshold such as thirty two frequencies, such as absolute radio-frequency channel numbers. Additionally, in one configuration, the maximum number of TD-SCDMA measurement objects in the active list is based on a TD-SCDMA threshold, such as, for example, six.

According to an aspect of the present disclosure, some layers from the IRAT measurement list are weighted such that frequencies associated with the layer will be searched a pre-determined number of times before being swapped out to the dormant list if a valid cell was not detected during each consecutive search procedure. For example, TD-SCDMA frequencies may be restricted so that they are unsuccessfully searched multiple (e.g., three) times before being swapped from the active list to the dormant list.

In another configuration, an IRAT database is updated after a successful IRAT handover/redirection event. The IRAT database may be referred to as the IRAT acquisition database. In one configuration, an IRAT acquisition database is specified to maintain a list of successful IRAT connected mode handover/redirection procedures. In this configuration, the IRAT acquisition database may include elements such as, but not limited to, serving RAT source information, such as a LTE global cell ID, target RAT information, such as a TD-SCDMA UTRA absolute radio frequency channel number and a counter for each TD-SCDMA UTRA absolute radio frequency channel number, and successful IRAT connected mode handover/redirection procedures. The counter refers to a count of a number of successful handover/redirection procedures between a first RAT, such as LTE, and a second RAT, such as TD-SCDMA.

The successful IRAT connected mode handover/redirection procedures may be used to initialize the initial search/active set. That is, the radio resource controller may use the IRAT database to prioritize the initial active search list for a layer 1 software module. Furthermore, the IRAT database may be written into a memory, such as the embedded file system, and is persistent across power-cycles.

In one configuration, the conventional IRAT database may be specified for specific UEs. Aspects of the present disclosure may extend the use of the conventional IRAT database to cache connected mode procedures such as handover/redirection. Moreover, the size of the IRAT database for the present configurations may be the same as the conventional IRAT database. In other words, the concepts of the present disclosure would not change affect the size of the database.

In one configuration, the target RAT radio resource controller provides the successful target RAT absolute radio frequency channel number to the source RAT radio resource controller when there is a successful source RAT to target RAT redirection or handover. Furthermore, the source RAT radio resource controller may update the IRAT database with the target RAT absolute radio frequency channel number associated with the source RAT global cell ID. It should be noted that because a handover can only be to a target handover frequency, the source RAT radio resource controller may only update the IRAT database for successful handover events. The source RAT is the RAT that was serving the UE prior to the redirection/handover.

As previously discussed, one LTE layer corresponds to one LTE measurement object, one TD-SCDMA layer corresponds to three TD-SCDMA measurement objects, and one GSM layer corresponds to all configured GSM measurement objects subject to a GSM layer threshold, such as thirty-two frequencies. Furthermore, in this configuration, when TD-SCDMA measurement objects are added to the measurement list, the UE should prioritize TD-SCDMA measurement objects from the IRAT database.

After adding the initial layers specified by the pruning criteria, the UE may add the remaining measurement objects based on measurement object IDs until the number of layers does not exceed the layer threshold. Furthermore, specific RAT measurement objects, such as TD-SCDMA measurement objects, that were not added to the active list may be added to the dormant list. Moreover, in one configuration, the remaining measurement objects may be added the IRAT measurement list based on a preference of a measurement event type.

That is, the UE may prepare an active list and dormant list for TD-SCDMA. The active list may have a specific TD-SCDMA measurement object threshold, such as six measurements objects, and the remaining measurement objects may be placed on the dormant list. Moreover, TD-SCDMA measurement objects that are from the IRAT database may be specified as weighted TD-SCDMA measurement objects.

After pruning the layers to the specified threshold, the UE determines whether the total number of LTE, GSM, and TD-SCDMA frequencies exceeds the frequency threshold. In one configuration, the UE initially prunes excessive TD-SCDMA measurement objects from the dormant list so that the number of frequencies is equal to or less than the frequency threshold. The UE may then prune excessive measurement objects from the active list if the number of frequencies still exceeds the frequency threshold after pruning the TD-SCDMA measurement objects from the dormant list.

TABLES 5-8 provide examples of various pruning scenarios. In the examples provided below, it is assumed that the UE is in an LTE connected mode and one serving LTE measurement object is always passed to the measurement list. It is also assumed that only valid measurement objects are considered for pruning. Finally, TABLES 5-7 are examples of one RRC connection reconfiguration message and TABLE 8 is an example of a UE receiving three RRC connection reconfiguration messages.

TABLE 5
6 LTE layers - Measurement Objects 1 to 6
16 TD-SCDMA layers - Measurement Objects 7 to 22
5 GSM layers - Measurement Objects 23 to 27 (Frequency count is within
32)
Pruned List (Conventional Network): 6 LTE + 1 TD-SCDMA + 1 LTE
Serving
Pruned List (Present example): 1 GSM (All 5 GSM Measurement Objects
if the frequency count is within 32) + 4 LTE + 2 TD-SCDMA (6 Measure-
ment Objects) + 1 LTE Serving in the Active list + 4 TDS (10 Measure-
ment Objects) in the Dormant list

In the example of TABLE 5 it is assumed that a UE is in an LTE connected mode and a layer threshold is eight. As shown in the example of TABLE 5, in a conventional network, the UE selects the six LTE layers because the six LTE layers are assigned to measurement objects one through six. Furthermore, the UE selects one TD-SCDMA layer that is assigned the next measurement object, which is measurement object seven.

Alternatively, in the example of TABLE 5, based on an aspect of the present disclosure, the UE initially populates the IRAT measurement list with a pre-determined number of layers, such as one serving LTE layer, one LTE inter-frequency layer, one GSM layer, and two TD-SCDMA layers. After adding the initial number of layers to the IRAT measurement list, the UE adds remaining layers to the IRAT measurement list so that the number of layers is less than or equal to a layer threshold. The remaining layers are added based on the assigned measurement object IDs. That is, the UE begins adding layers based on the lowest measurement object ID. Thus, in this example, as shown in TABLE 5, the UE adds three LTE layers corresponding to measurement object IDs two through four.

As previously discussed, when adding layers to satisfy the layer threshold, each TD-SCDMA layer corresponds to three layers. Therefore, the two TD-SCDMA layers in the active list of TABLE 5 correspond to six measurement objects. That is, one measurement object is specified for each frequency. Furthermore, as previously discussed the remaining TD-SCDMA layers may be specified for a dormant list. As shown in TABLE 5, sixteen measurement objects are specified for TD-SCDMA. Moreover, six measurement objects are assigned to the active list. Therefore, the remaining ten TD-SCDMA measurement objects are assigned to the dormant list. Furthermore, as previously discussed, each TD-SCDMA layer may correspond to up to three measurement objects. Thus, four TD-SCDMA layers are assigned to the dormant list.

That is, a first TD-SCDMA layer corresponds to the first three measurement objects in the dormant list, a second TD-SCDMA layer corresponds to the next three measurement objects in the dormant list, a third TD-SCDMA layer corresponds to the following three measurement objects in the dormant list, resulting in nine measurement objects. Additionally, the remaining measurement object corresponds to the fourth TD-SCDMA layer.

Furthermore, in the present example, the UE may prune frequencies from the IRAT measurement list if the total number of frequencies in the both the active list and the dormant list exceed a frequency threshold. Specifically, the UE may begin by pruning the frequencies in the dormant list prior to pruning frequencies in the active list. Still, in this example, because the number of frequencies is less than a frequency threshold, such as twenty two, the UE does not prune frequencies from the IRAT measurement list.

As shown in TABLE 5, in the conventional network, all GSM measurement objects and 15 TD-SCDMA measurement objects were pruned. Still, based on an aspect of the present disclosure, the active list includes five GSM measurement objects and six TD-SCDMA measurement objects.

TABLE 6
5 GSM layers - Measurement Objects 1 to 5 (Frequency count is within
32)
16 TD-SCDMA layers - Measurement Objects 6 to 21
6 LTE layers - Measurement Objects 22 to 28
Pruned List (Conventional Network): 1 GSM (5 Measurement Objects) +
6 TD-SCDMA + 1 LTE Serving
Pruned List (Present example): 1 GSM (All 5 GSM Measurement Objects
if frequency Count is within 32) + 4 LTE + 2 TD-SCDMA (6 Measure-
ment Objects) + 1 LTE Serving in the active list + 4 TDS (10 Measure-
ment Objects) in the dormant list

In the example of TABLE 6, it is assumed that a UE is in an LTE connected mode and a layer threshold is eight. As shown in the example of TABLE 6, in a conventional network, the UE selects the one GSM layer corresponding to measurement objects one through five and six TD-SCDMA layers corresponding to measurement objects six through eleven.

Alternatively, in the example of TABLE 6, based on an aspect of the present disclosure, the UE initially populates the IRAT measurement list with a pre-determined number of layers, such as one serving LTE layer, one LTE inter-frequency layer, one GSM layer, and two TD-SCDMA layers. After adding the initial number of layers to the IRAT measurement list, the UE adds remaining layers to the IRAT measurement list so that the number of layers is less than or equal to a layer threshold. The remaining layers are added based on the assigned measurement object ID. That is, the UE begins adding layers based on the lowest measurement object ID until the layer threshold is satisfied. If the number of available layers is less than the layer threshold, the UE adds all available layers to the IRAT measurement list.

In this example, because the GSM measurement objects are already on the active list, the next layers to be added based on the lowest measurement object ID are the TD-SCDMA layers. Still, there may be a maximum number of TD-SCDMA measurement objects on an active list, such as six TD-SCDMA measurement objects. Accordingly, because there are already six TD-SCDMA measurement objects assigned to the active list based on the pre-determined layers, the UE adds three layers from the LTE measurement objects so that the total number of layers on the active list is equal to the layer threshold.

As previously discussed, when adding layers to satisfy the layer threshold, each TD-SCDMA layer corresponds to three layers. Therefore, the two TD-SCDMA layers in the active list of TABLE 6 correspond to six measurement objects. Furthermore, as previously discussed the remaining TD-SCDMA layers may be assigned to a dormant list. As shown in TABLE 6, sixteen measurement objects are specified for TD-SCDMA. Six measurement objects are assigned to the active list. Therefore, the remaining ten measurement objects are assigned to the dormant list. Furthermore, as previously discussed, each TD-SCDMA layer may correspond to up to three measurement objects. Thus, four TD-SCDMA layers are assigned to the dormant list.

That is, a first TD-SCDMA layer corresponds to the first three measurement objects in the dormant list, a second TD-SCDMA layer corresponds to the next three measurement objects in the dormant list, a third TD-SCDMA layer corresponds to the following three measurement objects in the dormant list, resulting in nine measurement objects. Additionally, the remaining measurement object corresponds to the fourth TD-SCDMA layer.

Furthermore, in the present example, the UE may prune frequencies from the IRAT measurement list if the total number of frequencies in both the active list and the dormant list exceed a frequency threshold. Specifically, the UE would begin by pruning the frequencies in the dormant list prior to pruning frequencies in the active list. Still, in this example, because the number of frequencies is less than a frequency threshold, such as twenty two, the UE does not prune frequencies from the IRAT measurement list.

As shown in TABLE 6, in the conventional network, all LTE measurement objects and ten TD-SCDMA measurement objects are pruned. Still, based on an aspect of the present disclosure, the active list includes four LTE measurement objects.

TABLE 7
5 GSM layers - Measurement Objects 1 to 5 (Frequency count is within
32)
6 LTE layers - Measurement Objects 6 to 11
16 TD-SCDMA layers - Measurement Objects 12 to 27
Pruned List (Conventional Network): 1 GSM (5 Measurement Objects) +
6 LTE + 1 LTE Serving
Pruned List (Present example): 1 GSM (All 5 G Measurement Objects
if Frequency Count is within 32) + 4 LTE + 2 TDS (6 Measurement
Objects) + 1 LTE Serving in the active list + 4 TD-SCDMA (10 Measure-
ment Objects) in the dormant list

In the example of TABLE 7, it is assumed that a UE is in an LTE connected mode and a layer threshold is eight. As shown in the example of TABLE 7, in a conventional network, the UE selects the one GSM layer corresponding to measurement objects one through five and six LTE layers corresponding to measurement objects six through eleven.

Alternatively, in the example of TABLE 7, based on an aspect of the present disclosure, the UE initially populates the IRAT measurement list with a pre-determined number of layers, such as one serving LTE layer, one LTE inter-frequency layer, one GSM layer, and two TD-SCDMA layers. After adding the initial number of layers to the IRAT measurement list, the UE adds remaining layers to the IRAT measurement list so that the number of layers is less than or equal to a layer threshold. The remaining layers are added based on the assigned measurement object ID. That is, the UE begins adding layers based on the lowest measurement object ID until the layer threshold is satisfied. If the number of available layers is less than the layer threshold, the UE adds all available layers to the IRAT measurement list.

In this example, based on the pre-determined layers, up to three layers may be added so that the total number of layers is less than or equal to the layer threshold. Moreover, in this example, because the GSM measurement objects with the lower measurement object IDs are already on the active list, the next layers to be added based on the lowest measurement object IDs are the LTE layers. Therefore, the UE adds three LTE layers to the active list.

As previously discussed, when adding layers to satisfy the layer threshold, each TD-SCDMA layer corresponds to three layers. Therefore, the two TD-SCDMA layers in the active list of TABLE 7 correspond to six measurement objects. Furthermore, as previously discussed the remaining TD-SCDMA layers may be specified for a dormant list. As shown in TABLE 7, sixteen measurement objects are specified for TD-SCDMA. Moreover, six measurement objects are assigned to the active list. Therefore, the remaining ten measurement objects are assigned to the dormant list. Furthermore, as previously discussed, each TD-SCDMA layer may correspond to up to three measurement objects. Thus, four TD-SCDMA layers are assigned to the dormant list.

That is, a first TD-SCDMA layer corresponds to the first three measurement objects in the dormant list, a second TD-SCDMA layer corresponds to the next three measurement objects in the dormant list, a third TD-SCDMA layer corresponds to the following three measurement objects in the dormant list, resulting in nine measurement objects. Additionally, the remaining measurement object corresponds to the fourth TD-SCDMA layer.

Furthermore, in the present example, the UE may prune frequencies from the IRAT measurement list if the total number of frequencies in the both the active list and the dormant list exceed a frequency threshold. Specifically, the UE would begin by pruning the frequencies in the dormant list prior to pruning frequencies in the active list. Still, in this example, because the number of frequencies is less than a frequency threshold, such as twenty two, the UE does not prune frequencies from the IRAT measurement list.

As shown in TABLE 7, in the conventional network, all TD-SCDMA measurement objects were pruned. Still, based on an aspect of the present disclosure, the active list includes six TD-SCDMA measurement objects.

According to an aspect of the present disclosure, the UE may be configured to handle multiple event sequences. That is, when each RRC connection reconfiguration message is received, the radio resource controller determines if the maximum number of layers exceed the layer threshold. Furthermore, the radio resource controller prunes the layers based on the pruning criteria when the number of layers exceeds the layer threshold.

As an example, for a UE in an LTE connected mode, a first RRC connection reconfiguration may configure LTE IRAT measurement objects. For the first RRC connection reconfiguration, the IRAT measurement list is not populated based on the initial pre-determined number of layers because GSM and TD-SCDMA measurement objects are not configured. Still, the UE may constrain the number of layers based on the layer threshold.

Furthermore, for the second RRC connection reconfiguration the TD-SCDMA and/or GSM measurement objects may be configured. When the TD-SCDMA and/or GSM measurement objects are configured, the LTE radio resource controller may enforce the initial pre-determined number of layers which may cause the radio resource controller to prune layers if the number of layers exceeds the layer threshold. It should be noted that the pruning is specified only for valid measurement objects.

TABLE 8
{{Reconfig 1:}}
6 LTE Layers - Measurement Objects 1 to 6
No Pruning because the layer count is less than 8 (6 LTE Measurement
Objects)
{{Reconfig 2:}}
5 GSM layers - Measurement Objects 7 to 11
No Pruning because the layer count is less than 8 (6 LTE Measurement
Objects + 1 GSM Measurement Object)
{{Reconfig 3:}}
16 TD-SCDMA layers - Measurement Objects 12 to 27
Pruned List (Conventional Network): 1 GSM (5 Measurement Objects) +
6 LTE + 1 LTE Serving
Pruned List (Present Example): 1 GSM (All 5 GSM Measurement Objects
if Frequency Count is within 32) + 4 LTE + 2 TDS (6 Measurement
Objects) + 1 LTE Serving in the active list + 4 TDS (10 Measurement
Objects) in the dormant list

TABLE 8 illustrates an example of a UE assigning layers to a measurement list based on a given RRC connection reconfiguration message. In the example of TABLE 8, it is assumed that a UE is in an LTE connected mode and a layer threshold is eight.

As shown in TABLE 8, a UE may receive a first RRC connection reconfiguration message that specifies six LTE layers corresponding to six measurement objects and the six LTE layers are added to the active list. In this example, the UE does not prune the active list because the number of layers on the active list is less than the layer threshold.

Furthermore, as shown in TABLE 8, a UE may receive a second RRC connection reconfiguration message that specifies an additional five GSM layers corresponding to five measurement objects. In this example, one GSM layer is added to the active list and the added GSM layer corresponds to the five GSM measurement object IDs. Additionally, in this configuration, the UE does not prune the active list because the number of layers on the active list is less than the layer threshold.

Additionally, as shown in TABLE 8, a UE may receive a third RRC connection reconfiguration message that specifies an additional sixteen GSM layers corresponding to sixteen measurement objects.

As shown in example of TABLE 8, in a conventional network, the UE selects the six LTE layers corresponding to measurement objects one through six and one GSM layer corresponding to measurement objects seven through eleven.

Alternatively, in the example of TABLE 8, based on an aspect of the present disclosure, the UE initially populates the IRAT measurement list with a pre-determined number of layers, such as one serving LTE layer, one LTE inter-frequency layer, one GSM layer, and two TD-SCDMA layers. After adding the initial number of layers to the IRAT measurement list, the UE adds remaining layers to the IRAT measurement list so that the number of layers is less than or equal to a layer threshold. The remaining layers are added based on the assigned measurement object ID. That is, the UE begins adding layers based on the lowest measurement object ID until the layer threshold is satisfied. If the number of available layers is less than the layer threshold, the UE adds all available layers to the IRAT measurement list.

In this example, based on the pre-determined layers, up to three layers may be added so that the total number of layers is less than or equal to the layer threshold. Thus, in this example, the next layers to be added based on the lowest measurement object ID are the LTE layers. Therefore, the UE adds three LTE layers to the active list.

As previously discussed, when adding layers to satisfy the layer threshold, each TD-SCDMA layer corresponds to three layers. Therefore, the two TD-SCDMA layers in the active list of TABLE 8 correspond to six measurement objects. Furthermore, as previously discussed the remaining TD-SCDMA layers may be specified for a dormant list. As shown in TABLE 8, sixteen measurement objects are specified for TD-SCDMA. Moreover, six measurement objects are assigned to the active list. Therefore, the remaining ten measurement objects are assigned to the dormant list. Furthermore, as previously discussed, each TD-SCDMA layer may correspond to three measurement objects, thus, four TD-SCDMA layers are assigned to the dormant list.

That is, a first TD-SCDMA layer corresponds to the first three measurement objects in the dormant list, a second TD-SCDMA layer corresponds to the next three measurement objects in the dormant list, a third TD-SCDMA layer corresponds to the following three measurement objects in the dormant list, resulting in nine measurement objects. Additionally, the remaining measurement object corresponds to the fourth TD-SCDMA layer.

Furthermore, in the present example, the UE may prune frequencies from the IRAT measurement list if the total number of frequencies in both the active list and the dormant list exceeds a frequency threshold. Specifically, the UE would begin by pruning the frequencies in the dormant list prior to pruning frequencies in the active list. Still, in this example, because the number of frequencies is less than a frequency threshold, such as twenty two, the UE does not prune frequencies from the IRAT measurement list.

As shown in TABLE 8, in the conventional network, all TD-SCDMA measurement objects were pruned. Still, based on an aspect of the present disclosure, the active list includes six TD-SCDMA measurement objects.

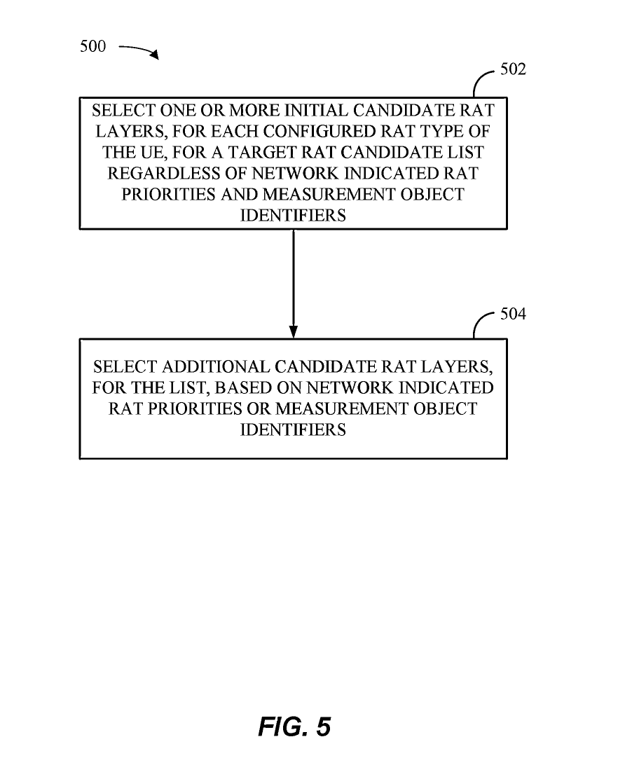

FIG. 5 shows a wireless communication method 500 according to one aspect of the disclosure. A UE selects one or more initial candidate RAT layers, for each configured RAT type of the UE, for a target RAT candidate list, as shown in block 502. In one configuration, each initial candidate RAT layer is selected regardless of network indicated RAT priorities and measurement object identifiers. The UE also selects additional candidate RAT layers, for the list, based on the network indicated RAT priorities or the measurement object identifiers, as shown in block 504.

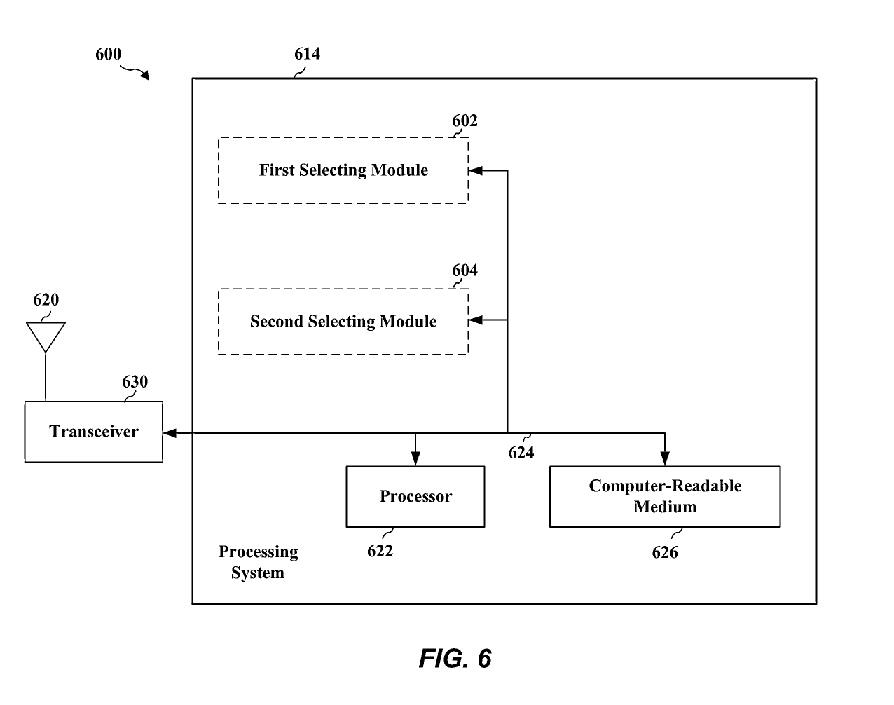

FIG. 6 is a diagram illustrating an example of a hardware implementation for an apparatus 600 employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware modules, represented by the processor 622 the module 602, 604, and the computer-readable medium 626. The bus 624 may also link various other circuits such as timing sources, peripherals, voltage regulators, and power management circuits, which are well known in the art, and therefore, will not be described any further.

The apparatus includes a processing system 614 coupled to a transceiver 630. The transceiver 630 is coupled to one or more antennas 620. The transceiver 630 enables communicating with various other apparatus over a transmission medium. The processing system 614 includes a processor 622 coupled to a computer-readable medium 626. The processor 622 is responsible for general processing, including the execution of software stored on the computer-readable medium 626. The software, when executed by the processor 622, causes the processing system 614 to perform the various functions described for any particular apparatus. The computer-readable medium 626 may also be used for storing data that is manipulated by the processor 622 when executing software.

The processing system 614 includes a first selecting module 602 for selecting one initial candidate RAT layer, for each configured RAT of a UE, for a target RAT candidate list. In one configuration, each initial candidate RAT layer is selected regardless of network indicated RAT priorities and measurement object identifiers. The processing system 614 also includes a second selecting module 604 for selecting additional candidate RAT layers, for the list, based at on the network indicated RAT priorities or the measurement object identifiers. The selecting modules 602, 604 may be one module or separate modules.

The modules may be software modules running in the processor 622, resident/stored in the computer-readable medium 626, one or more hardware modules coupled to the processor 622, or some combination thereof. The processing system 614 may be a component of the UE 350 and may include the memory 392, and/or the controller/processor 390.

In one configuration, an apparatus such as a UE is configured for wireless communication including means for selecting. In one aspect, the selecting means may be the receiver 354, the channel processor 394, the receive frame processor 360, the receive processor 370, the controller/processor 390, 622, the memory 392, the selecting module 391, the first selecting module 602, the second selecting module 604, and/or the processing system 614 configured to perform the functions recited by the aforementioned means.

In another configuration, the aforementioned means may be any module or any apparatus configured to perform the functions recited by the aforementioned means.

Several aspects of a telecommunications system has been presented with reference to LTE, GSM, and TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE)-advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for determining candidate radio access technology (RAT) layers, comprising:
selecting at least one initial candidate RAT layer, for each configured RAT type of a user equipment (UE), for a target RAT candidate list, each initial candidate RAT layer being selected regardless of network indicated RAT priorities and measurement object identifiers (IDs); and
selecting additional candidate RAT layers, for the list, based at least in part on the network indicated RAT priorities or the measurement object IDs.

2. The method of claim 1, in which the at least one initial candidate RAT layer is selected based at least in part on a preference of a network operator that is servicing the UE.

3. The method of claim 1, in which a first initial candidate RAT layer is an LTE layer, a second initial candidate RAT layer is a TD-SCDMA layer, and third initial candidate RAT layer is a GSM layer.

4. The method of claim 3, in which the TD-SCDMA layer is associated with a plurality of TD-SCDMA frequencies.

5. The method of claim 1, in which the additional candidate RAT layers are selected based at least in part on a number of supported layers for the target RAT candidate list.

6. The method of claim 5, in which the number of supported layers for the target RAT candidate list is at least eight and a number of supported frequencies for the target RAT candidate list is based at least in part on at least a size of UE memory, an estimated time for searching, or a combination thereof.

7. The method of claim 1, further comprising selecting the additional candidate RAT layers based at least in part on a preference of a measurement event type when the additional candidate RAT layers are selected based on the measurement object IDs.

8. An apparatus for determining candidate radio access technology (RAT) layers, the apparatus comprising:
a memory unit; and
at least one processor coupled to the memory unit, the at least one processor being configured:
to select at least one initial candidate RAT layer, for each configured RAT type of a user equipment (UE), for a target RAT candidate list, each initial candidate RAT layer being selected regardless of network indicated RAT priorities and measurement object identifiers (IDs); and
to select additional candidate RAT layers, for the list, based at least in part on the network indicated RAT priorities or the measurement object IDs.

9. The apparatus of claim 8, in which the at least one candidate RAT layer is selected based at least in part on a preference of a network operator that is servicing the UE.

10. The apparatus of claim 8, in which a first initial candidate RAT layer is an LTE layer, a second initial candidate RAT layer is a TD-SCDMA layer, and third initial candidate RAT layer is a GSM layer.

11. The apparatus of claim 10, in which the TD-SCDMA layer is associated with a plurality of TD-SCDMA frequencies.

12. The apparatus of claim 8, in which the additional candidate RAT layers are selected based at least in part on a number of supported layers for the target RAT candidate list.

13. The apparatus of claim 12, in which the number of supported layers for the target RAT candidate list is at least eight and a number of supported frequencies for the target RAT candidate list is based at least in part on at least a size of UE memory, an estimated time for searching, or a combination thereof.

14. The apparatus of claim 8, in which the additional candidate RAT layers are selected based at least in part on a preference of a measurement event type when the additional candidate RAT layers are selected based on the measurement object IDs.

15. A apparatus for determining candidate radio access technology (RAT) layers, the apparatus comprising:
means for selecting at least one initial candidate RAT layer, for each configured RAT type of a user equipment (UE), for a target RAT candidate list, each initial candidate RAT layer being selected regardless of network indicated RAT priorities and measurement object identifiers (IDs); and
means for selecting additional candidate RAT layers, for the list, based at least in part on the network indicated RAT priorities or the measurement object IDs.

16. The apparatus of claim 15, in which the at least one candidate RAT layer is selected based at least in part on a preference of a network operator that is servicing the UE.

17. The apparatus of claim 15, in which a first initial candidate RAT layer is an LTE layer, a second initial candidate RAT layer is a TD-SCDMA layer, and third initial candidate RAT layer is a GSM layer.

18. The apparatus of claim 17, in which the TD-SCDMA layer is associated with a plurality of TD-SCDMA frequencies.

19. The apparatus of claim 15, in which the additional candidate RAT layers are selected based at least in part on a number of supported layers for the target RAT candidate list.

20. The apparatus of claim 19, in which the number of supported layers for the target RAT candidate list is at least eight and a number of supported frequencies for the target RAT candidate list is based at least in part on at least a size of UE memory, an estimated time for searching, or a combination thereof.

21. The apparatus of claim 15, in which the selecting means selects additional candidate RAT layers based at least in part on a preference of a measurement event type when the additional candidate RAT layers are selected based on the measurement object IDs.

22. A computer program product for wireless communications, the computer program product comprising:
a non-transitory computer-readable medium having program code recorded thereon, the program code being executed by a processor and comprising:
program code to select at least one initial candidate RAT layer, for each configured RAT type of a user equipment (UE), for a target RAT candidate list, each initial candidate RAT layer being selected regardless of network indicated RAT priorities and measurement object identifiers (IDs); and
program code to select additional candidate RAT layers, for the list, based at least in part on the network indicated RAT priorities or the measurement object IDs.

23. The computer program of claim 22, in which the at least one candidate RAT layer is selected based at least in part on a preference of a network operator that is servicing the UE.

24. The computer program of claim 22, in which a first initial candidate RAT layer is an LTE layer, a second initial candidate RAT layer is a TD-SCDMA layer, and third initial candidate RAT layer is a GSM layer.

25. The computer program of claim 24, in which the TD-SCDMA layer is associated with a plurality of TD-SCDMA frequencies.

26. The computer program of claim 22, in which the additional candidate RAT layers are selected based at least in part on a number of supported layers for the target RAT candidate list.

27. The computer program of claim 26, in which the number of supported layers for the target RAT candidate list is at least eight and a number of supported frequencies for the target RAT candidate list is based at least in part on at least a size of UE memory, an estimated time for searching, or a combination thereof.

28. The computer program of claim 22, in which the code to select selects additional candidate RAT layers based at least in part on a preference of a measurement event type when the additional candidate RAT layers are selected based on the measurement object IDs.
